(19) United States
(12) Patent Application Publication
(10) Pub. No.: US 2020/0286129 A1
(43) Pub. Date: Sep. 10, 2020

(54) ADVERTISEMENT OUTPUT DECISION SYSTEM AND ADVERTISEMENT OUTPUT DECISION METHOD

(71) Applicant: TOYOTA JIDOSHA KABUSHIKI KAISHA, Toyota-shi (JP)

(72) Inventor: Makoto HONDA, Tokyo (JP)

(73) Assignee: TOYOTA JIDOSHA KABUSHIKI KAISHA, Toyota-shi (JP)

(21) Appl. No.: 16/807,755

(22) Filed: Mar. 3, 2020

(30) Foreign Application Priority Data
Mar. 5, 2019 (JP) 2019-039493

(51) Int. Cl. G06Q 30/02; G06N 5/04

(52) U.S. Cl. CPC G06Q 30/0266; G06N 5/045

(57) ABSTRACT

An advertisement output decision system includes an acquisition unit configured to acquire positional information or scheduled route information of a providing vehicle providing a service, and a decision unit configured to, based on the positional information or the scheduled route information of the providing vehicle, decide advertisement information to be output to a display provided in the providing vehicle or a user terminal device that is able to order the service. The decision unit is configured to decide an output of advertisement information for making an order for the service to be provided by the providing vehicle to the user terminal device positioned in a providable area derived based on the scheduled route information.

### INCORPORATION BY REFERENCE

The disclosure of Japanese Patent Application No. 2019-039493 filed on Mar. 5, 2019 including the specification, drawings and abstract is incorporated herein by reference in its entirety.

### BACKGROUND

### 1. Technical Field

The present disclosure relates to a technique that decides an output of advertisement information.

### 2. Description of Related Art

Japanese Unexamined Patent Application Publication No. 2015-97094 (JP 2015-97094 A) discloses a real-time bidding system that adjusts pricing and distribution of an advertisement placement using a competing economic valuation model in response to a request to place an advertisement. The real-time bidding system automatically adjusts a channel for distributing an advertisement or a position for placing an advertisement based on data of advertisement performance and predicts the price for an advertisement placement opportunity based on data of advertisement performance and the past bidding price.

### SUMMARY

In a case where a providing vehicle that can provide a food service or a commodity sales service is moving, it is preferable that an advertisement relating to the providing vehicle is effectively output.

The disclosure provides a technique for effectively outputting advertisement information relating to a providing vehicle providing a service.

A first aspect of the disclosure relates to an advertisement output decision system. The advertisement output decision system includes an acquisition unit and a decision unit. The acquisition unit is configured to acquire positional information or scheduled route information of a providing vehicle providing a service. The decision unit is configured to, based on the positional information or the scheduled route information of the providing vehicle, decide advertisement information to be output to a display provided in the providing vehicle or a terminal device of a user who is able to place an order for the service.

A second aspect of the disclosure relates to an advertisement output decision method. The method includes a step of acquiring positional information or scheduled route information of a providing vehicle providing a service, and a step of, based on the positional information or the scheduled route information of the providing vehicle, deciding advertisement information to be output to a display provided in the providing vehicle or a terminal device of a user who is able to place an order for the service.

According to the aspects of the disclosure, it is possible to provide a technique for effectively outputting advertisement information relating to a providing vehicle providing a service.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a perspective view schematically showing a providing vehicle according to an embodiment;

FIG. 2 is a diagram showing the outline of the functional configuration of an advertisement output decision system;

FIG. 3 is a diagram showing the functional configuration of the advertisement output decision system;

FIG. 4 is a diagram showing a scheduled route of the providing vehicle;

FIG. 5 is a diagram showing advertisement-use information that is held in an advertisement-use information holding unit; and

FIG. 6 is a flowchart showing sales processing of an advertisement distribution right.

### DETAILED DESCRIPTION OF EMBODIMENTS

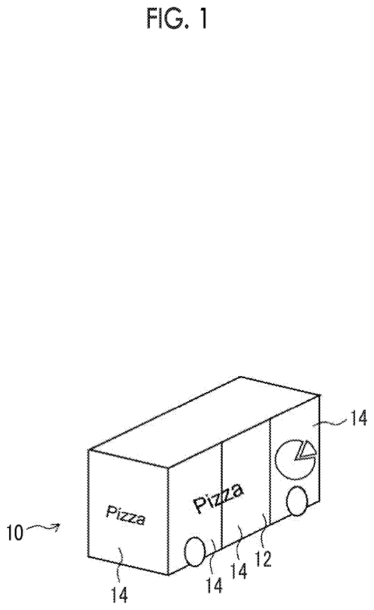

FIG. 1 is a perspective view schematically showing a providing vehicle 10 according to an embodiment. The providing vehicle 10 provides a service determined in advance. Examples of the service include a food service, a commodity sales service, a financial service, a medical service, an energy providing service, an administrative service, a transit service, and the like, but are not particularly limited. Articles that are mounted in the providing vehicle 10 are set according to a service to be provided.

The providing vehicle 10 is, for example, an electric vehicle and can travel in an autonomous driving mode, but is not particularly limited. In a case where the providing vehicle 10 can perform autonomous driving, the providing vehicle 10 travels in an autonomous driving mode along a route set in advance, and an occupant of the providing vehicle 10 can provide a service without driving the providing vehicle 10.

The providing vehicle 10 includes a door 12 and a plurality of displays 14. The door 12 is provided, for example, on at least one side surface of the providing vehicle 10, and is slid to be opened and closed. The displays 14 are provided on a front surface, both side surface, and a rear surface of the providing vehicle 10, and on the door 12. The displays 14 may be provided inside the vehicle as well as the outside of the providing vehicle 10. The displays 14 may display video related to the service to be provided by the providing vehicle 10 as advertisement information or may display video of other services. For example, in a case where the providing vehicle 10 provides a food service, specifically, a pizza sales service, as shown in FIG. 1, the displays 14 display characters “Pizza” and an image of a pizza related to the pizza sales service, and display advertisement information of the service to be provided by the providing vehicle 10.

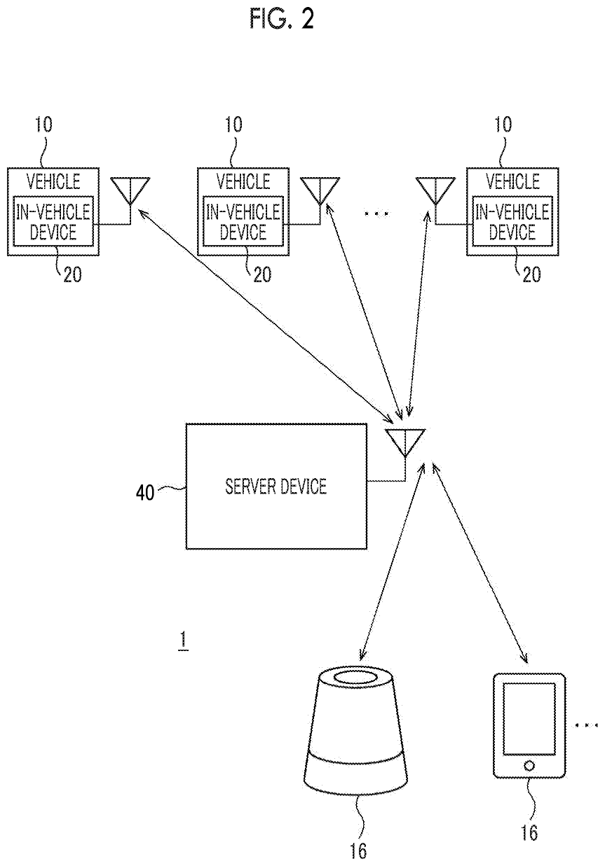

FIG. 2 is a diagram showing the outline of the functional configuration of an advertisement output decision system 1. The advertisement output decision system 1 includes a plurality of in-vehicle devices 20, a plurality of user terminal devices 16, and a server device 40.

The in-vehicle devices 20 are mounted in the providing vehicle 10 and are connected to the server device 40 through a network. The in-vehicle devices 20 executes autonomous driving control of the providing vehicle 10, transmission of positional information to the server device 40, output control of the displays 14, and the like. The in-vehicle devices 20 receives an order of provision of the service to an orderer through the server device 40.

The user terminal devices 16 are smartphones, smart speakers, or the like, and are connected to the server device 40 through the network. The user terminal devices 16 can execute an application program for using the service to be provided by the providing vehicle 10.

For example, in a case where the service to be provided by the providing vehicle 10 is the pizza sales service, the user terminal devices 16 can output advertisement information “Will you order a pizza?” of the providing vehicle 10 and can place an order to the providing vehicle 10 for a pizza. The user terminal devices 16 function as advertisement distribution destination terminals of the service.

The server device 40 receives the order for the service to be provided by the providing vehicle 10 and outputs advertisement information relating to the service to the user terminal devices 16. The server device 40 may sell a right to distribute the advertisement information to the user terminal devices 16 to a service provider of the providing vehicle 10.

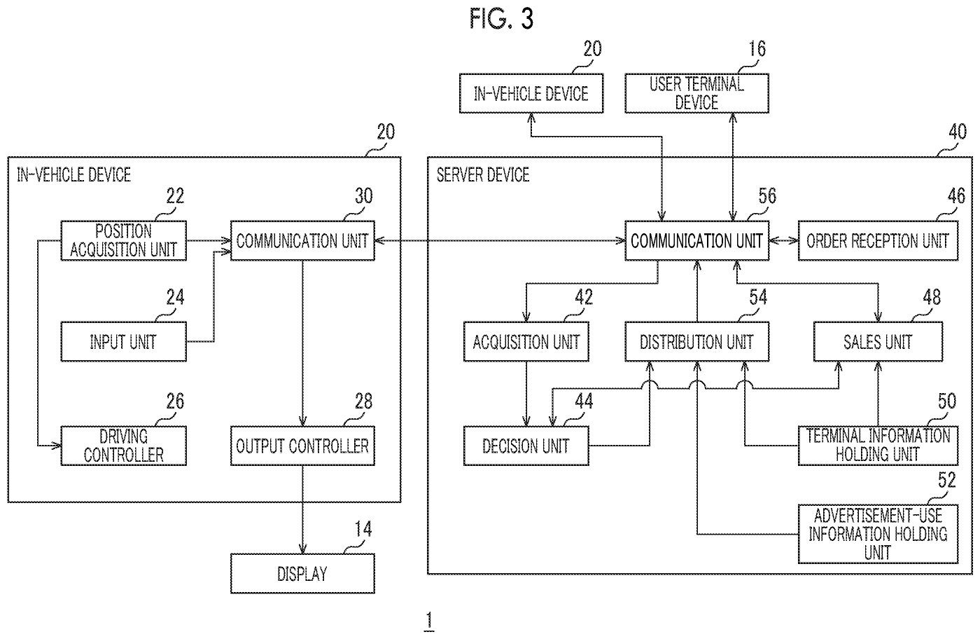

FIG. 3 is a diagram showing the functional configuration of the advertisement output decision system 1. In FIG. 3, elements that are described as functional blocks for executing various kinds of processing can be constituted of a circuit block, a memory, and other LSIs in terms of hardware or are implemented by a program or the like loaded in a memory in terms of software. Accordingly, it can be understood by those skilled in the art that the functional blocks can be implemented in various forms by hardware solely, software solely, or a combination of hardware and software, and are not limited to either one.

Each of the in-vehicle devices 20 has a position acquisition unit 22, an input unit 24, a driving controller 26, an output controller 28, and a communication unit 30. The server device 40 has an acquisition unit 42, a decision unit 44, an order reception unit 46, a sales unit 48, a terminal information holding unit 50, an advertisement-use information holding unit 52, a distribution unit 54, and a communication unit 56.

The position acquisition unit 22 of the in-vehicle device 20 acquires positional information of the providing vehicle 10 using a global positioning system (GPS) and an acquisition time of the positional information. The position acquisition unit 22 may acquire the positional information of the providing vehicle from an in-vehicle navigation device. Furthermore, the position acquisition unit 22 may acquire scheduled route information indicating a movement route for scheduled traveling from the navigation device. In the scheduled route information, a scheduled arrival time to a destination may be included. The providing vehicle 10 may be set so as to travel along a circulating route in advance in a case where an order for the service is not placed, may receive the circulating route, that is, the scheduled route information from the server device 40, and may move according to the scheduled route information. The positional information and/or the scheduled route information of the providing vehicle 10 is transmitted to the server device 40 through the communication unit 30.

The input unit 24 receives an input from the service provider. For example, the input unit 24 receives an input for purchasing the right (hereinafter, referred to as an “advertisement distribution right”) to distribute the advertisement information to the user terminal devices 16. Input information indicating purchase is transmitted to the server device 40 through the communication unit 30. Even though the advertisement distribution right is not purchased, the advertisement information may be distributed to the user terminal devices 16.

The driving controller 26 performs autonomous driving along a scheduled route set in advance. The driving controller 26 makes the providing vehicle 10 travel based on information of an in-vehicle camera, information of a millimeter-wave radar, information of a sound wave sensor, or the like. The output controller 28 performs control such that the advertisement information is displayed on the displays 14.

The order reception unit 46 of the server device 40 receives the order for the service from the user terminal devices 16. Order information for the service includes details of the service to be ordered, positional information of an order source, a scheduled time when the provision of the service is desired, and the like. For example, in the pizza sales service, the kind of a pizza, an address of the order source to which the pizza is delivered, and a scheduled arrival time to the order source are received as the order information for the service.

The acquisition unit 42 acquires the positional information and/or the scheduled route information of the providing vehicle 10 through the communication unit 56 and transmits the positional information and/or the scheduled route information to the decision unit 44. The acquisition unit 42 acquires a preparation time of the service to be provided by the providing vehicle 10, for example, a cooking time in a case where food is provided, and transmits the cooking time to the decision unit 44.

The decision unit 44 decides advertisement information to be output to the user terminal device 16 based on the positional information and/or the scheduled route information of the providing vehicle 10 and advertisement information to be output to the displays 14. The advertisement information to be output to the user terminal devices 16 is to prompt the use of the service, and in a case of the pizza sales service, is output, for example, like “A pizza will be distributed at 12:00, and will you order a pizza?”. The decision unit 44 derives an area where the providing vehicle 10 can provide the service based on the positional information or the scheduled route information of the providing vehicle 10 and outputs the advertisement information to the user terminal devices 16 in the providable area. With this, it is possible to advertise the service to customers within a range in which the providing vehicle 10 can provide the service.

In the embodiment, there are a method of distributing advertisement information sold by the sales unit 48 described below and a method of distributing advertisement information decided by the decision unit 44 without passing through the sales unit 48. The advertisement information of the service provider is distributed even though the advertisement distribution right is not purchased by the sales unit 48; however, in a case where the service provider desires more advertisement information, the advertisement distribution right is purchased from the sales unit 48.

A timing of advertisement distribution may be every one hour, every several hours, or twice in the afternoon and evening. The advertisement information is distributed to the user terminal devices 16 about twice a day. The decision unit 44 generates a list of user terminal devices 16, to which the advertisement information of the providing vehicle 10 is distributed, from a plurality of user terminal devices 16 positioned in an area where the providing vehicle 10 can provide the service.

The decision unit 44 generates the list of the user terminal devices 16, to which the advertisement information of the providing vehicle 10 is distributed, based on the scheduled route information of the providing vehicle 10 and the positional information of the user terminal devices 16. For example, the decision unit 44 distributes the advertisement information with priority to the user terminal devices 16 positioned near the scheduled route of the providing vehicle 10.

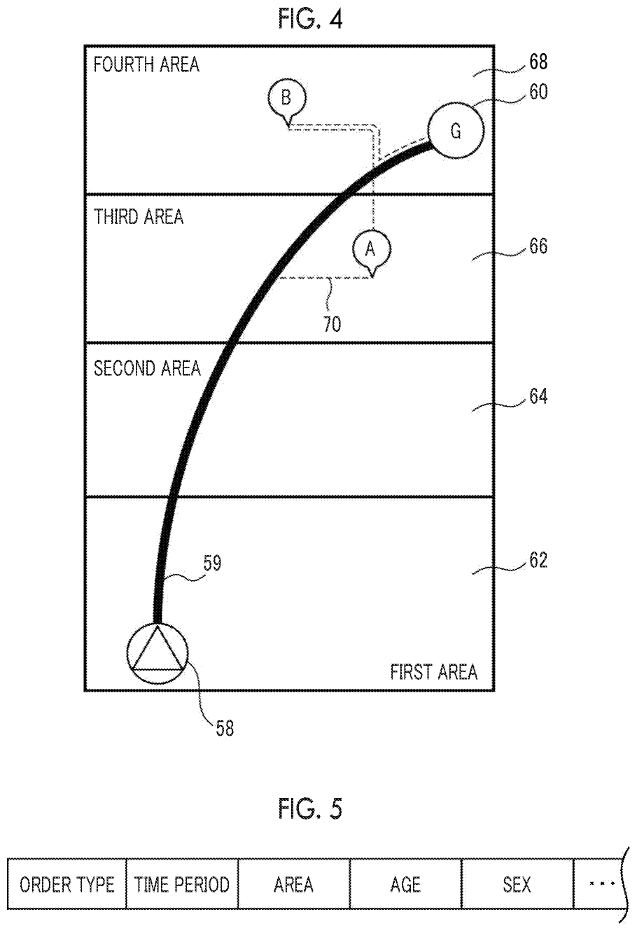

FIG. 4 is a diagram showing the scheduled route of the providing vehicle 10. The providing vehicle 10 moves along a scheduled route 59 from a vehicle position 58 toward a destination 60, and is scheduled to pass through a first area 62, a second area 64, a third area 66, and a fourth area 68.

The decision unit 44 derives a providable area, in which the service can be provided, based on the scheduled route 59 of the providing vehicle 10. In a case where the pizza sales service is provided, the decision unit 44 excludes the first area 62 and the second area 64 near a current position in relation to the cooking time of a pizza, derives the third area 66 and the fourth area 68 as a providable area of the service, and distributes the advertisement information to the user terminal devices 16 positioned in the third area 66 and the fourth area 68. In this way, the providable area may be derived based on the cooking time for providing the service, in addition to the scheduled route 59. With this, the service provider in the providing vehicle 10 can perform cooking during movement and can arrive at the order source after cooking is completed.

The advertisement information that is output to the user terminal device 16 is to make the user place an order for the service to be provided by the providing vehicle 10. Any user views the advertisement information and places an order, and the order reception unit 46 receives an order of provision of a service from the user terminal devices 16 positioned at a point A and a point B.

For example, in a case where there are first providing vehicles 10 that are operated by X company and second providing vehicles 10 that are operated by Y company, advertisement information that is output to the user terminal devices 16 is distributed while distinguishing between placing an order to the first providing vehicles 10 for a service and placing an order to the second providing vehicles 10 for a service. That is, different advertisement information is distributed to each providing vehicle 10. In a case where the number of first providing vehicles 10 that are operated by X company is five, common advertisement information related to the five first providing vehicles 10 may be distributed.

The driving controller 26 receives an order from the point A and the point B, changes the route from the scheduled route 59 to a delivery route 70, and directs the providing vehicle 10 toward a destination 60 by way of the point A and the point B. An occupant of the providing vehicle 10 receives the order during movement and prepares for service provision, such as cooking in the vehicle.

Returning to FIG. 2, the decision unit 44 may derive the providable area of the service based on the positional information of the providing vehicle 10 and may output the advertisement information to the user terminal devices 16 positioned in the providable area. In a case where the providing vehicle 10 is on standby, the periphery of a standby position of the providing vehicle 10 is derived as the providable area of the service.

In generating the list of the user terminal devices 16 to which the advertisement information of the providing vehicle 10 is distributed, the decision unit 44 refers to user information held in the terminal information holding unit 50.

The terminal information holding unit 50 holds a terminal ID of the user terminal device 16, preference information of the user, an order history of the user, and the positional information of the user terminal device 16 in association with one another. The preference information of the user is generated according to an order history from the user terminal device 16, for example, an order frequency of the ordered service. The positional information of the user terminal device 16 may be address information set in advance by the user or may be acquired by a GPS. The terminal information holding unit 50 may hold behavior information of the user, and the behavior information may be schedule information of the user or a behavior history based on the positional information of the user terminal device 16. As the advertisement information is distributed based on the behavior information of the user, it is possible to distribute advertisement information relating to a meal at a timing before the user has a meal.

The decision unit 44 refers to the preference information of the user and the order history of the user, and generates the list of the user terminal devices 16, to which the advertisement information of the providing vehicle 10 is distributed, according to the degree of similarity of the service to be provided by the providing vehicle 10 and the preference information of the user, and an order time period based on the order history of the user.

The decision unit 44 may generate the list of the user terminal devices 16, to which the advertisement information of the providing vehicle 10 is distributed, based on advertisement-use information. The advertisement-use information is information generated based on the order history, and shows the degree of demand for the service.

FIG. 5 is a diagram showing the advertisement-use information that is held in the advertisement-use information holding unit 52. The advertisement-use information is information in which each order is associated with the kind of the ordered service, the ordered time period, the area of the order source, the age of the order source, the sex of the order source, and the like. As the decision unit 44 refers to the advertisement-use information, for example, it is possible to derive how many “pizza” or “noodle” is ordered on average in the first area 62 in a time period of 12:00 to 13:00. The age or sex of the order source may be acquired as user information of the order source from the terminal information holding unit 50.

The decision unit 44 generates the list of the user terminal devices 16, to which the advertisement information of the providing vehicle 10 is distributed, with reference to the degree of demand for the service indicated in the advertisement-use information. The decision unit 44 calculates the ratio of the degree of demand of an order kind, such as “noodle”, “pizza”, or “buckwheat noodle”, for each area and each time period, and generates the list of the user terminal devices 16 with allocation of the number of the user terminal devices 16 according to the ratio of the degree of demand of the order kind for the service provider of each of “noodle”, “pizza”, “buckwheat noodle”, and the like. For example, in a case where the ratios of the degrees of demand for “noodle”, “pizza”, and “buckwheat noodle” are 50 percent, 30 percent, and 20 percent, respectively, a list in which 50 percent of the user terminal devices 16 in a predetermined area are allocated to the service provider of “noodle” is generated, a list in which 30 percent of the user terminal devices 16 are allocated to the service provider of “pizza” is generated, and a list in which 20 percent of the user terminal devices 16 are allocated to the service provider of “buckwheat noodle” is generated. With this, it is possible to output the advertisement information according to the degree of demand.

Returning to FIG. 2, the sales unit 48 sells the advertisement distribution right to the service provider of the providing vehicle 10. For example, the advertisement distribution right to a predetermined number of user terminal devices 16 in the first area 62 at 11:00 a.m., the advertisement distribution right to a predetermined number of user terminal devices 16 in the second area 64 at 6:00 p.m., or the like is sold. In the advertisement distribution right, the number of user terminal devices 16, to which an advertisement is distributed, an advertisement distribution time, and an advertisement distribution area are set.

In a case where there are the first providing vehicle 10, with which X company performs a pizza sales service, and the second providing vehicle 10, with which Y company performs a pizza sales service, and in a case where the service provider of the first providing vehicle 10 purchases the advertisement distribution right, advertisement information that prompts to make an order to the first providing vehicles 10 is distributed.

The sales unit 48 may transmit the advertisement-use information held in the advertisement-use information holding unit 52 to the in-vehicle device 20 and may make the service provider read the degree of demand for the service on the display 14 inside the vehicle. With this, the service provider can view the degree of demand for the service indicated in the advertisement-use information and can purchase the advertisement distribution right. The input unit 24 receives an input for purchasing the advertisement distribution right. The decision unit 44 may derive the providable area of the service based on the positional information or the scheduled route information of the providing vehicle 10, and the sales unit 48 may sell the advertisement distribution right to the providable area to the service provider of the providing vehicle 10. With this, the service provider can bid solely the advertisement distribution right that is distributed in the providable area of the providing vehicle 10.

The sales unit 48 may decide the price of the advertisement distribution right based on the advertisement-use information. With this, it is possible to decide the advertisement distribution right according to the degree of demand for the service. The sales unit 48 may calculate the number of potential customers based on the advertisement-use information for each area and may calculate the price of the advertisement distribution right based on the calculated number of potential customers. Alternatively, the sales unit 48 may derive the degree of demand for the service based on the number of potential customers of each area and may set the advertisement distribution right.

The number of potential customers may be derived based on the number of user terminal devices 16 in the area and the order history or may be derived based on a movement route of the providing vehicle 10 in a predetermined area and a predetermined time period. For example, the number of potential customers may be calculated to be greater as a frequency in which movement routes of a plurality of providing vehicles 10 pass through a predetermined area in a predetermined time period is greater. As the number of potential customers of each area is derived, it is possible to effectively advertise in an area where the number of potential customers is large. The number of potential customers in each area and each time period may be held as the advertisement-use information in the advertisement-use information holding unit 52.

The sales unit 48 may sell the advertisement distribution right in an auction form at each predetermined time. In the advertisement distribution right, the time period, the distribution area, the number of terminals to which the advertisement is distributed are decided. For example, in a case where the number of providing vehicle 10 that provides the pizza sales service is ten, ten service providers make a bid the individual advertisement distribution right. The service provider that makes a bid at the highest price successfully bids the advertisement distribution right. As the advertisement distribution right is sold in an auction form, it is possible to sell the advertisement distribution right at high price.

The decision unit 44 sets the advertisement distribution right based on the advertisement-use information held in the advertisement-use information holding unit 52, and the sales unit 48 sells the set advertisement distribution right. The decision unit 44 sets the advertisement distribution right with allocation of the number of the user terminal devices 16 according to the ratio of the degree of demand for the service with reference to the degree of demand for the service indicated in the advertisement-use information. The decision unit 44 sets the advertisement distribution right such that many advertisement distribution terminals are allocated to the kind of the service having the high degree of demand in the predetermined area and the predetermined time period.

The sales unit 48 may sell the advertisement information that is output to the displays 14 on the outside of the providing vehicle 10. The decision unit 44 may decide the advertisement information to be output to the displays of the providing vehicle 10 based on the scheduled route information of the providing vehicle 10. With this, the providing vehicle 10 functions as an advertising vehicle. The decision unit 44 receives a sales result of the sales unit 48 and decides an output of advertisement information according to the sales result.

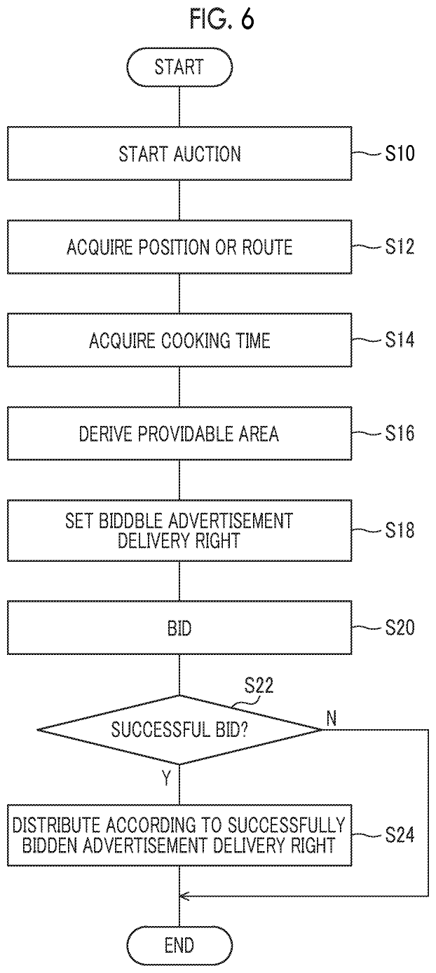

FIG. 6 is a flowchart showing sales processing of the advertisement distribution right. The sales unit 48 starts auction processing at a predetermined timing (S10). The predetermined timing may be, for example, every one hour or every two hours.

The acquisition unit 42 acquires the positional information or the route information of the providing vehicle 10 from the in-vehicle device 20 (S12), and acquires the cooking time of the service to be provided by the providing vehicle 10 (S14).

The decision unit 44 derives a providable area of the service based on the positional information or the route information of the providing vehicle 10 (S16). The sales unit 48 sets a biddable advertisement distribution right for each service provider of the providing vehicle 10 based on the derived providable area (S18). The service provider confirms the biddable advertisement distribution right and makes a bid through the input unit 24 (S20).

In a case where the service provider cannot successfully bid the advertisement distribution right (in S22, N), the present processing ends. In a case where the service provider can successfully bid the advertisement distribution right (in S22, Y), distribution of an advertisement is decided, and the distribution unit 54 distributes the advertisement to an area set in the advertisement distribution right, a time period, and the list of the user terminal devices 16 (S24).

The disclosure has been described above based on the above-described embodiment. The embodiment is intended to be just illustrative, and it will be obvious to those skilled in the art that various modification examples can be made to a combination of components or processes and that such modification examples also fall within the scope of the disclosure.

In the embodiment, although an aspect in which the order reception unit 46 is provided in the server device 40 has been described, the disclosure is not limited to the aspect, and the configuration of the order reception unit 46 may be provided in the in-vehicle device 20.

What is claimed is:

1. An advertisement output decision system comprising:
an acquisition unit configured to acquire positional information or scheduled route information of a providing vehicle providing a service; and
a decision unit configured to, based on the positional information or the scheduled route information of the providing vehicle, decide advertisement information to be output to a display provided in the providing vehicle or a terminal device of a user who is able to order the service.

2. The advertisement output decision system according to claim 1, wherein the decision unit is configured to decide an output of advertisement information for making an order for the service to be provided by the providing vehicle to the terminal device positioned in a providable area derived based on the positional information or the scheduled route information of the providing vehicle.

3. The advertisement output decision system according to claim 2, further comprising a sales unit configured to sell a right to distribute advertisement information to the terminal device positioned in the providable area.

4. The advertisement output decision system according to claim 1, further comprising a sales unit configured to sell an advertisement distribution right to be output to a display provided on an outside of the providing vehicle while the providing vehicle is moving along a scheduled route.

5. The advertisement output decision system according to claim 3, wherein the sales unit sells the advertisement distribution right in an auction form.

6. An advertisement output decision method comprising:
a step of acquiring positional information or scheduled route information of a providing vehicle providing a service; and
a step of, based on the positional information or the scheduled route information of the providing vehicle, deciding advertisement information to be output to a display provided in the providing vehicle or a terminal device that is able to order the service.
